(19) United States
(12) Patent Application Publication
(10) Pub. No.: US 2024/0124324 A1
(43) Pub. Date: Apr. 18, 2024

(54) WATER PURIFICATION DEVICE

(71) Applicants: Mohd. Shkir, Abha (SA); King Khalid University, Abha (SA)

(72) Inventors: Mohd Ubaidullah, Riyadh (SA); Anuj Kumar, Mathura (IN); Mohd. Shkir, Abha (SA); Ala Manohar, Gyeongsan (KR); S.M. Al-Moayid, Abha (SA); Bidhan Pandit, Leganés, Madrid (ES); Haitham Elhosiny Ali, Abha (SA); Hamed Majdooa Algarni, Abha (SA); Manish Gupta, Phagwara, Punjab (IN)

(21) Appl. No.: 18/517,104

(22) Filed: Nov. 22, 2023

(51) Int. Cl. C02F 1/00

(52) U.S. Cl. CPC C02F 1/003; C02F 2301/08

(57) ABSTRACT

The present invention generally relates to a water purification device designed to operate primarily on gravitational force. The device comprises an inlet chamber (102) for storing surface water; and a filtration chamber (104) placed beneath the inlet chamber housing: a first filter made up of a 1:3 mixture of zeolite and acid-fractionalized activated charcoal, supported on a cotton bed; a second filter (104B) consisting of powdered eggshell membrane mixed with zeolite and Fe₃O₄ nanoparticles in a 5:3:1 ratio; and a third filter (104C) composed of a mixture of eggshell membrane powder, zeolite, Fe₃O₄, and AgNO₃ nanoparticles, all supported on a cotton bed in a 5:3:1:1 ratio; and an outlet (106) adjusted at a bottom section for collecting purified water. The surface water enters from a top of the filtration chamber and is subjected to gravitational force, leading it through the series of filters towards the outlet.

### FIELD OF THE INVENTION

The present disclosure relates to water purification devices and systems. Specifically, the invention pertains to a water purification device designed to operate primarily on gravitational force and a method for preparing such a device. The present invention falls within the broader domain of fluid purification and treatment, and it is particularly beneficial for applications where electrical or mechanical pumping systems may be impractical or unavailable. This gravitational water purification device can be employed in various settings, including households, outdoor recreational activities, emergency relief situations, and areas without consistent access to electricity or clean water.

### BACKGROUND OF THE INVENTION

The critical and escalating issue of clean water scarcity is felt globally. Water hardness, a prevailing concern in various water supplies, is principally attributed to the ready dissolution of specific minerals in water. However, hardness is just one facet of the broader water contamination problem. Certain water sources, especially those proximate to industrial areas, might be tainted with carcinogenic substances. One of the most alarming of these carcinogenic elements is Chromium (IV)—a toxin characterized by its mobility in water systems. In addition to this, other dangerous elements like arsenic (As) and lead (Pb) have been detected in groundwater, especially in industrialized zones.

Beyond the threat of carcinogenic metals, another formidable challenge lies in the existence of pathogenic microorganisms in the water. Traditional water purification methods often fall short of completely eradicating these harmful pathogens. Over the years, several techniques have been devised to alleviate the water hardness problem, including the L-S process, zeolite process, ion-exchange process, Calgon conditioning, and reverse osmosis. However, the elimination of waterborne carcinogens on a large scale remains unaddressed. To combat pathogenic threats, methods like chlorination, ozonization, and UV radiation have been adopted, but their efficacy in comprehensive water purification is not always assured.

In view of the foregoing discussion, it is portrayed that there is a need to have a water purification device designed to operate primarily on gravitational force and a method of preparing a water purification device.

### SUMMARY OF THE INVENTION

The present disclosure seeks to provide a water purification device with four columns, each of which contains three filtering beds: the top bed is made of functionalized graphene resting on a cotton bed, the middle bed is made of a cotton-supported bed on which a membrane made of neutral powdered egg shells is distributed in a uniform thickness, and the bottom bed is made of a reduced egg-shell membrane resting on a cotton bed. When a sample of water including hardness, carcinogenic metals, and pathogens is transported from the top of the device down the second bed, over 100% of the hardness and carcinogenic metal are filtered out, and the number of pathogenic organisms is reduced by approximately 30%. However, after the third bed, 100% of the pathogens are either destroyed or screened out. This process yielded water that is free of hardness-inducing salts, carcinogenic salts, and microorganisms.

In an embodiment, a water purification device to operates primarily on gravitational force is disclosed. The device includes an inlet chamber adjustable based on a volumetric capacity mounted on a top section for storing surface water.

The device further includes a filtration chamber placed beneath the inlet chamber housing: a first filter made up of a 1:3 mixture of zeolite and acid-fractionalized activated charcoal, supported on a cotton bed; a second filter consisting of powdered eggshell membrane mixed with zeolite and Fe₃O₄ nanoparticles in a 5:3:1 ratio; and a third filter composed of a mixture of eggshell membrane powder, zeolite, Fe₃O₄, and AgNO₃ nanoparticles, all supported on a cotton bed in a 5:3:1:1 ratio.

The device further includes an outlet adjusted at a bottom section for collecting purified water. The surface water enters from the top of the filtration chamber and is subjected to gravitational force, leading it through the series of filters toward the outlet.

In another embodiment, a method of preparing a water purification device is disclosed. The method includes mounting an inlet chamber at the top of a bucket. Then, designing a filtration chamber by: arranging a first filter positioned at a top of a column; arranging a second filter positioned in a middle of the column; and arranging a third filter positioned at a bottom of the column.

The method further includes arranging one or more filtration chambers inside the bucket parallelly and maintaining a surface water height from the filtration chambers to sustain a user-defined filtration rate.

The method further includes adjusting an outlet at a bottom of the bucket for collecting purified water from the bucket.

Yet, in another embodiment, a method for filtering surface water using a water purification device comprises receiving and storing surface water inside the inlet chamber (102). Then, passing the surface water through the filtration chamber (104) to filter impurities from the surface water, wherein water passes sequentially through the first, second, and third filters, resulting in purified water devoid of particulate matter, significant hardness, carcinogenic metals, and pathogenic organisms. Then, storing the filtered water in a bucket. Thereafter, collecting purified water from the bucket through the outlet (106).

An object of the present disclosure is to introduce a water purification system capable of removing nearly 100% of water hardness and carcinogenic metals like Chromium (IV).

Another object of the present disclosure is to effectively reduce the presence of harmful pathogenic microorganisms in water by approximately 70% through the filtration system and to ensure that any residual pathogens after the third filter bed are either significantly diminished or entirely eradicated.

Another object of the present disclosure is to harness the power of gravitational force, negating the need for electricity or mechanical systems. This makes the device particularly suitable for regions with inconsistent access to power, emergencies, or outdoor recreational activities.

Another object of the present disclosure is to incorporate three distinct filters, each tailored for specific contaminants, into a single purification device. These filters, when systematically arranged in columns, offer a sequential and comprehensive purification process.

Another object of the present disclosure is to utilize materials like eggshell membranes, zeolite, and specific nanoparticles, which can potentially offer an affordable and sustainable approach to water purification compared to some conventional methods.

Another object of the present disclosure is to ensure the resultant water is free from deleterious chemicals, metals, or organisms that could induce hardness or health hazards, providing a safe and clean water source for consumption and use.

Another object of the present disclosure is to promote a method that minimizes waste, relies on readily available or renewable resources, and reduces the carbon footprint typically associated with electrically driven water purification systems.

Yet another object of the present invention is to deliver an expeditious and cost-effective device that can be adapted to various settings, from households to larger community setups, and can be customized (3-4 columns) based on specific purification needs.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a block diagram of a water purification device, in accordance with an embodiment of the present disclosure;

FIG. 2 illustrates a flow chart of a method of preparing a water purification device, in accordance with an embodiment of the present disclosure;

FIG. 3 illustrates exemplary views of the water purification device, in accordance with an embodiment of the present disclosure, with FIG. 3(a) illustrating illustrates inside view of the device; FIG. 3(b) illustrating inside front of the device, and FIG. 3(c) illustrating top view of the device.;

FIG. 4 illustrates the adsorption capacity and removal (%) of Filter 2, and Filter 3 towards As (V), in accordance with an embodiment of the present disclosure;

FIG. 5 illustrates a working principle of the designed device to purify the surface water, in accordance with an embodiment of the present disclosure;

FIG. 6 illustrates a water hardness removal efficiency via composite filter 2 (Red Blue) and filter 3 (Sky Blue), in accordance with an embodiment of the present disclosure;

FIG. 7 illustrates the antimicrobial Activity of Composite Filter 3 at 100 mg/ml concentration, in accordance with an embodiment of the present disclosure;

FIG. 8 illustrates Table 1 depicts the chemical composition of artificial water and surface water, in accordance with an embodiment of the present disclosure;

FIG. 9 illustrates Table 2 depicts the chemical composition of outlet water after filtration, in accordance with an embodiment of the present disclosure; and

FIG. 10 illustrates Table 3 depicts the antimicrobial activity of Filter 2 and 3, in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

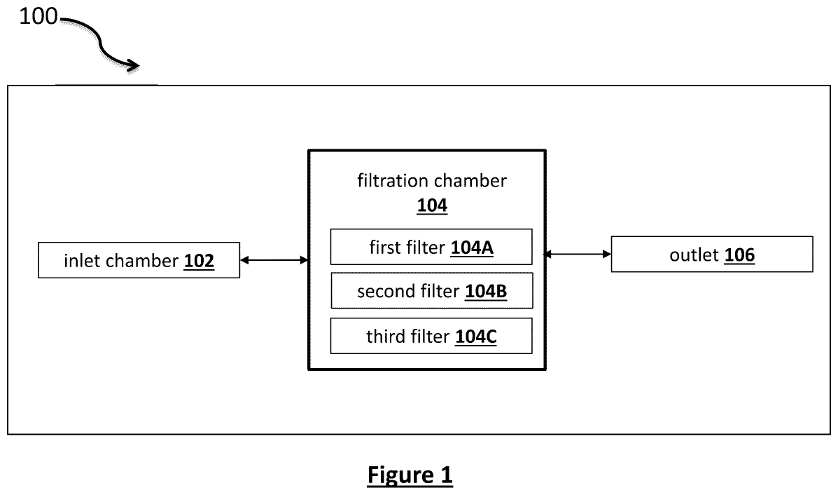

Referring to FIG. 1, a block diagram of a water purification device is illustrated in accordance with an embodiment of the present disclosure. The system 100 includes an inlet chamber (102) adjustable based on a volumetric capacity mounted on a top section for storing surface water.

In an embodiment, a filtration chamber (104) is placed beneath the inlet chamber (102) housing a first filter (104A) made up of a 1:3 mixture of zeolite and acid-fractionalized activated charcoal, supported on a cotton bed.

In one embodiment, a second filter (104B) consisting of a powdered eggshell membrane mixed with zeolite and Fe₃O₄ nanoparticles in a 5:3:1 ratio.

In one embodiment, a third filter (104C) composed of a mixture of eggshell membrane powder, zeolite, Fe₃O₄, and AgNO₃ nanoparticles, all supported on a cotton bed in a 5:3:1:1 ratio.

In an embodiment, an outlet (106) is adjusted at a bottom section for collecting purified water.

The surface water enters from a top of the filtration chamber (104) and is subjected to gravitational force, leading it through the series of filters towards the outlet (106).

In another embodiment, the first, second, and third filters are adjusted in a bucket-like container, systematically arranged in columns, wherein the first, second, and third filters are positioned in such a way that the first filter (104A) is at the top, the second filter (104B) is in the middle, and the third filter (104C) is at the bottom.

In another embodiment, after the surface water passes through the series of filters, nearly 100% of hardness and carcinogenic metals are filtered out, and the pathogenic organisms are reduced by nearly 70%, wherein any remaining pathogenic organisms are substantially eliminated after passing through the third filter (104C).

In another embodiment, maintaining a consistent surface water height in the filtration chamber (104) is advisable to sustain the filtration rate.

In another embodiment, a centrifugation procedure is conducted under ambient conditions, specifically at a temperature of 25° C. and an absolute pressure close to 1 atm, using a rotational speed of 5000 revolutions per minute for 10 minutes.

In another embodiment, the first filter (104A) comprises a perforated support structure integrated within a filter medium to promote uniform flow distribution and maximize contact between untreated water and the filtration media, wherein the second filter (104B) further including a magnetic separation feature using Fe₃O₄ nanoparticles for capturing iron particles, wherein the third filter (104C) incorporating an antibacterial mechanism with AgNO₃ nanoparticles, along with a quick-detach mechanism for easy replacement and periodic maintenance, wherein a flow control and monitoring system with sensors within the filtration chamber to monitor filter saturation levels and a variable flow control mechanism adjusting flow rate based on contamination levels.

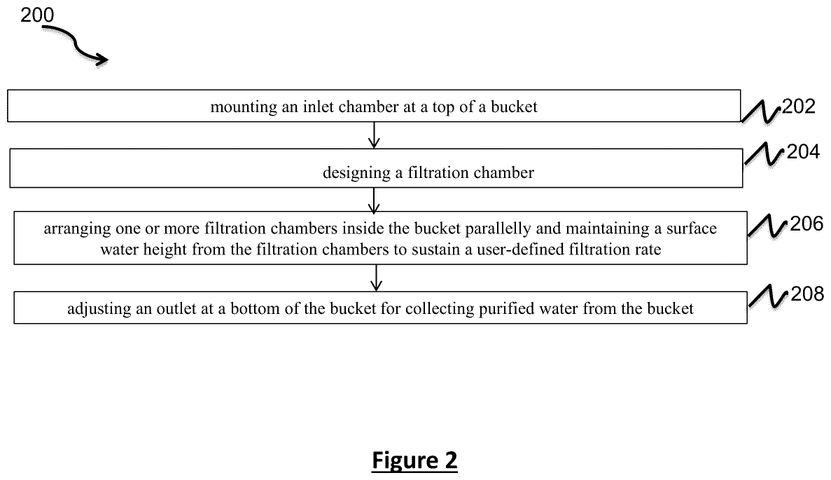

FIG. 2 illustrates a flow chart of a method of preparing a water purification device, in accordance with an embodiment of the present disclosure. At step 202, method 200 includes mounting an inlet chamber (102) at a top of a bucket.

At step 204, method 200 includes designing a filtration chamber (104) by preparing and arranging a first filter (104A) positioned at a top of a column, preparing and arranging a second filter (104B) positioned in a middle of the column, and preparing and arranging a third filter (104C) positioned at a bottom of the column.

At step 206, method 200 includes arranging one or more filtration chambers inside the bucket parallelly and maintaining a surface water height from the filtration chambers to sustain a user-defined filtration rate.

At step 208, method 200 includes adjusting an outlet (106) at a bottom of the bucket for collecting purified water from the bucket.

In another embodiment, a process for creating the first filter (104A) comprises performing charcoal acid treatment by placing 1 g of activated charcoal into a 500 mL flask and adding 10 mL of concentrated HNO₃ to the flask followed by adding 30 mL of concentrated H₂SO₄ to prepare a mixture. Then, swirling the mixture gently to evenly distribute the mixture. Then, heating the flask at 120° C. upon tightly closing the flask to avoid evaporation, wherein a heating mantle or a water bath is employed for controlled heating. Then, removing the flask from the heat source and allowing it to cool to room temperature thereby transferring a resultant suspension to centrifuge tubes. Then, centrifuging the suspension to separate the acid-treated charcoal from the liquid. Then, discarding the supernatant (upper liquid layer) from the centrifuge tubes and add distilled water to the charcoal residue and swirl to wash followed by centrifuging again to separate the water from the charcoal. Then, repeating the washing process several times until the wash water is neutral, and spreading the charcoal out on a drying tray or using an oven to dry to obtain a dry black powder. Then, preparing the filter bed by mixing zeolite and dried acid-treated charcoal in a 1:1 ratio using a mortar and pestle thereby grinding the mixture until a homogenous paste is formed. Thereafter, applying the charcoal-zeolite paste onto a cotton bed uniformly and allowing the filter to dry.

In another embodiment, a process for creating the second filter (104B) comprises extracting an eggshell by drilling a small hole in the egg and removing egg white or yolk thereby rinsing an interior of the eggshell with water to remove any residual egg white or yolk. Then, submerging the eggshell in a solution of 0.1 M acetic acid and soaking the eggshell for 6 hours. Then, separating a membrane from the dissolved CaCO₃ layer of the eggshell post-soak by peeling off the membrane away from the remaining shell fragments. Then, cleaning the membrane by rinsing the separated membrane with deionized water until neutrality is achieved. Then, drying the rinsed membrane and pulverizing the membrane into a fine powder using the mortar and pestle. Then, preparing the filter bed by combining the powdered eggshell, zeolite, and Fe₃O₄ nanoparticles in a 5:3:1 ratio, respectively, and mixing thoroughly until a homogenous paste is formed. Thereafter, applying the homogenous paste onto a cotton bed and drying the filter.

In another embodiment, a process for creating the third filter (104C) comprises mixing the powdered eggshell, zeolite, Fe₃O₄, and AgNO₃ nanoparticles in a 5:3:1:1 ratio, respectively. Then, heating the combined solution to approximately 90° C. Stir the mixture continuously while heating it to 90° C. Then, maintaining the solution at 90° C. while continuously stirring for about 3 hours. Then, adding a KOH solution to the heated mixture. Then, agitating the mixture containing the KOH solution at room temperature for an additional 2 hours until neutralization is achieved. Then, spreading the resultant uniform paste onto a cotton bed to form the filter. Thereafter, allowing the applied paste on the cotton bed to set and dry, thereby yielding a filter ready for use.

In another embodiment, a method for filtering surface water using a water purification device comprises receiving and storing surface water inside the inlet chamber (102). Then, passing the surface water through the filtration chamber (104) to filter impurities from the surface water, wherein water passes sequentially through the first, second, and third filters, resulting in purified water devoid of particulate matter, significant hardness, carcinogenic metals, and pathogenic organisms. Then, storing the filtered water in the bucket. Thereafter, collecting purified water from the bucket through the outlet (106).

In another embodiment, the first filter (104A) further comprises an activated carbon to enhance the removal of organic contaminants from the surface water, wherein the second filter (104B) includes a self-cleaning mechanism using ultrasonic vibrations to dislodge and remove accumulated contaminants, thereby extending the lifespan of the second filter, wherein the third filter (104C) incorporates a photocatalytic material in conjunction with AgNO₃ nanoparticles, facilitating the degradation of organic pollutants and enhancing the antibacterial properties of the filtration process.

In another embodiment, the method further comprises the step of pre-treating the surface water with a pre-filtration unit positioned upstream of the filtration chamber (104), the pre-filtration unit is configured to remove large debris and coarse particles before the surface water enters the first filter. Then, filtering water stored in the bucket by a UV-C irradiation, the UV-C irradiation is configured to deactivate residual pathogenic organisms, ensuring microbial safety of the stored purified water.

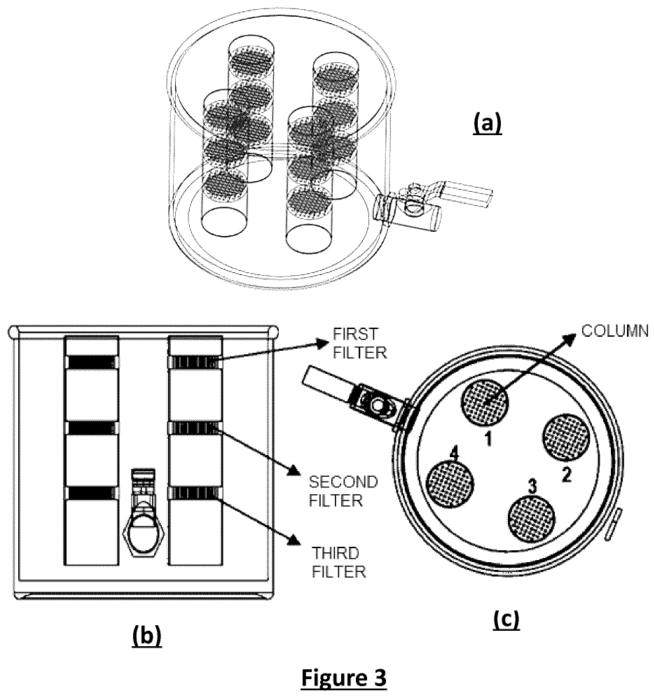

FIG. 3 illustrates exemplary profiles of the water purification device, in accordance with an embodiment of the present disclosure. FIG. 3(a) illustrates inside view of the device. FIG. 3(b) illustrates inside front of the device, and FIG. 3(c) illustrates top view of the device. In this invention, three filters have been developed;

First Filter (104A): this filter is made by a mixture of zeolite and acid-factionalized activated charcoal supported on a cotton bed.

Second Filter (104B): this is made by mixing neutral powdered eggshell membrane and hydroxyl groups functionalized Fe₃O₄ nanoparticles.

Third Filter: This filter is made of a paste of egg-shell membrane, zeolite, Fe₃O₄, and AgNO₃ nanoparticles, resting on a cotton bed.

These filters can be adjusted in a water bucket, arranging in 3-4 columns (depending on requirements) systematically, the first filter (104A) at the top of the column, the second filter (104B) at the middle of the column, and the third filter (104C) at the bottom of the column as shown in FIG. 3. After passing a contaminated water sample (containing hardness, carcinogenic metals like Cr(IV), and pathogens) through these filters, nearly 100% of the hardness and carcinogenic metals can be filtered out, and the number of pathogenic organisms is reduced by nearly 70%. However, after the third bed, any remaining infections are either eliminated or filtered out. Finally, the resulting water did not include any of the harmful chemicals or bacteria that might cause hardness or cancer.

The present disclosure seeks to provide a strategy for manufacturing a filter to remove the hardness, carcinogenic metals, and pathogenic organisms from the water.

The present process also discloses the use of three filters to purify the water.

The invention will provide the filters with potent yet non-toxic antibacterial and bactericidal capabilities.

The present invention also discloses the water filters that are extremely safe for the human body at the food level.

First Filter (104a): This filter is created using a 1:3 ratio of zeolite and acid-factionalized activated charcoal supported on a cotton bed. 1 g charcoal is put into a 500 mL flask, 10 mL concentrated HNO₃, and 30 mL concentrated H₂SO₄ are added, and the mixture is heated at 120° C. The resultant suspension is centrifuged and washed numerous times until neutral and dried. The resultant black powder is then mixed with zeolite (1:1) to form a homogenous paste, which is then applied to a cotton bed.

Second Filter: This is made by mixing neutral powdered eggshell membrane, zeolite, and Fe₃O₄ nanoparticles. To make the second filter, a hole is drilled in an egg, emptied its contents, and then soaked the shell in 0.1 M molar acetic acid for 6 hours to separate the membrane from the shell. The CaCO₃ layer of the egg is dissolved in acetic acid after the membrane had been removed. Additionally, the membrane recovered from the eggshell is cleaned with is deionized water until it is neutral, and then it is dried and pulverized into a powder. The powdered membrane of an egg is then combined with zeolite, and Fe₃O₄ to form a paste, which is then applied to the cotton bed.

Filter third: The third filter (104C) is made by mixing eggshell membrane powder with zeolite, Fe₃O₄, and AgNO₃ nanoparticles in an aqueous solution while stirring at 90° C. for 3 hours. Then, KOH solution is added to neutralize the aqueous solution, and the mixture is agitated for 2 hours at room temperature. The obtained uniform paste is then spread on a bed of cotton.

For the preparation of the second composite filter, powdered eggshell, zeolite, and Fe₃O₄ nanoparticles are taken in a 5:3:1 ratio.

For the preparation of the third composite filter, a ratio of powdered eggshell, zeolite, Fe₃O₄, and AgNO₃nanoparticles is 5:3:1:1.

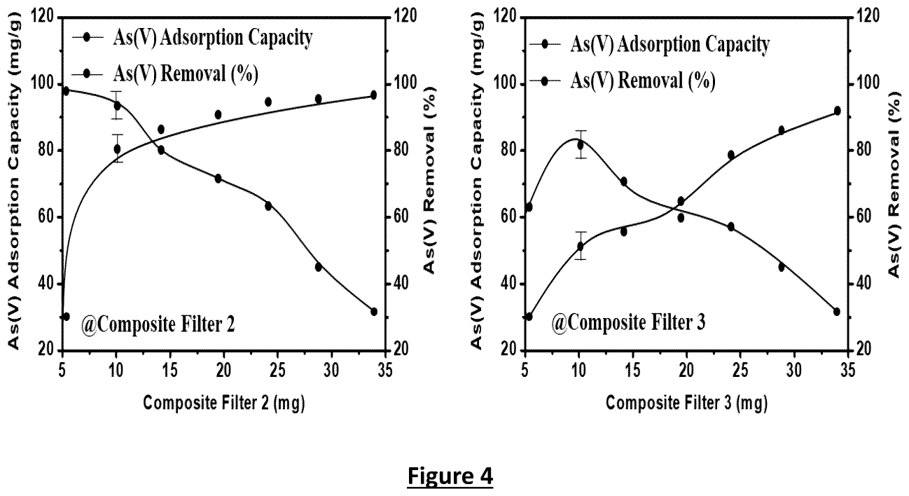

FIG. 4 illustrates the adsorption capacity and removal (%) of Filter 2, and Filter 3 towards As(V), in accordance with an embodiment of the present disclosure. Usually, zeolites can be used as cation exchangers and molecular sieves. The Ca²⁺ and Mg²⁺ ions of hard water get trapped in zeolites pores, and exchanged with Na⁺ ions, and released Na⁺ gets trapped on the Fe₃O₄ nanoparticles, removing the hardness of the water. In addition, the carcinogenic metals, Arsenic, cadmium, and chromium, in particular, possess high affinity towards O-atoms and get adsorbed on Fe₃O₄ nanoparticles via O-functionalities.

Moreover, to evaluate the feasibility of composite filter 2 (eggshell powder+zeolites+Fe₃O₄ nanoparticles) and composite filter 3 (eggshell powder+zeolites+Fe₃O₄ nanoparticles+AgNO₃nanoparticles) as an adsorbent for As(V) removal, the adsorption properties of both the composite filters are systematically explored by studying adsorption isotherm, and kinetics. The results showed that the composite filter 2 and 3 has a specific surface area of 320, and 325 m²/g and has excellent adsorption performance, respectively. At 25° C., the initial concentration of As(V) is 31.35 mg/L and 30.43 mg/L for the composite filter 2 and composite filter 3 to adsorb arsenic, respectively. The results indicated the efficiency of removal of As(V) of composite filters 2 and 3 as 98.1% and 91.05% (FIG. 4). The adsorption process of As(V) to these composite filters 2 and 3 could be demonstrated by the Langmuir isotherm second-order kinetic model, demonstrating 98.31, and 62.23 mg/g maximum As adsorption capacity, respectively, which can be attributed to higher O-functionalities distributed over the surface area of these composite filters. Therefore, the water passing from the second filter (104B) will be soft, and free from Arsenic, cadmium, and chromium.

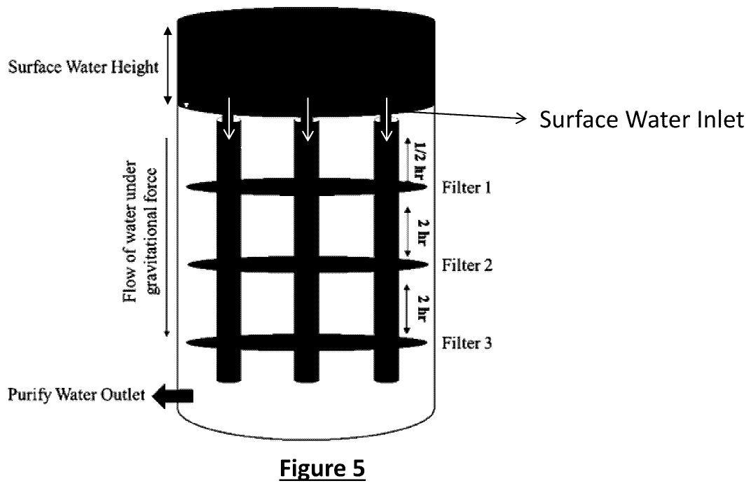

FIG. 5 illustrates a working principle of the designed device to purify the surface water, in accordance with an embodiment of the present disclosure. The working principle of the designed device is clearly illustrated in FIG. 5.

### Process of Filter 1

This filter effectively eliminates particulate matter such as dust clouds and muddy particles.

### Process of Filter 2

Usually, zeolites can be used as cation exchangers and molecular sieves. In this filter, the Ca²⁺ and Mg²⁺ ions of hard water get trapped in zeolites pores, and exchanged with Na⁺ ions, and released Na⁺ gets trapped on the Fe₃O₄ nanoparticles, removing the hardness of the water. Table 1 and Table 2 showed the hardness data before the filtration and after filtration, respectively. FIG. 5 shows a simple comparison of the removal of hardness of water from artificial hard water, drinking water, and surface water using filters 2 and 3.

In addition, the carcinogenic metals, Arsenic, cadmium, and chromium, in particular, possess high affinity towards O-atoms and get adsorbed on Fe₃O₄ nanoparticles via O-functionalities. To evaluate the feasibility of composite filter 2 (eggshell powder+zeolites+Fe₃O₄ nanoparticles) and composite filter 3 (eggshell powder+zeolites+Fe₃O₄ nanoparticles+AgNO₃ nanoparticles) as an adsorbent for As(V) removal, the adsorption properties of both the composite filters are systematically explored by studying adsorption isotherm, and kinetics. The results showed that the composite filter 2 and 3 has a specific surface area of 320, and 325 m²/g and has excellent adsorption performance, respectively. At 25° C., the initial concentration of As(V) is 31.35 mg/L and 30.43 mg/L for the composite filter 2 and composite filter 3 to adsorb arsenic, respectively. The results indicated the efficiency of removal of As(V) of composite filters 2 and 3 as 98.1% and 91.05% (FIG. 5). The adsorption process of As(V) to these composite filters 2 and 3 could be demonstrated by the Langmuir isotherm second-order kinetic model, demonstrating 98.31, and 62.23 mg/g maximum As adsorption capacity, respectively, which can be attributed to higher O-functionalities distributed over the surface area of these composite filters. Therefore, the water passing from the second filter (104B) will be soft, and free from Arsenic, cadmium, and chromium.

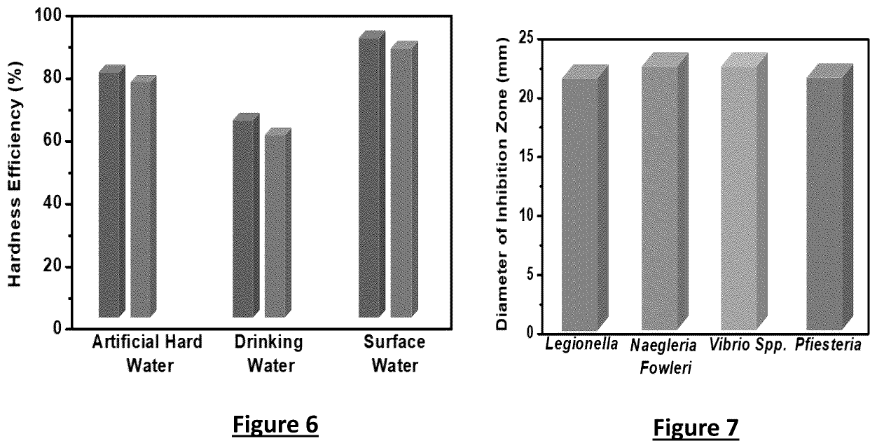

FIG. 6 illustrates a water hardness removal efficiency via composite filter 2 (Red Blue) and filter 3 (Sky Blue), in accordance with an embodiment of the present disclosure. Process of Filter 3: To check the antibacterial activity of filters 2 and 3, artificial hard water and surface water samples are used. Estimation of pathogens is made before and after filtration in 3 rd step, no pathogen is traced after filtration. In addition, the antimicrobial activity of the composite filters 2 and 3 was checked, and the results are illustrated in Table 3. The results confirm that the invented device succeeded in removing the pathogenic contamination from the surface water, providing potable water (FIG. 6).

Usually, few devices use filtration, for instance, Aqua Guard, Livpure, V-Guard, Havells Aquas, etc., but all the existing devices involve many steps as well as consume electricity to be functionalized. Our device is electricity-free, simple, and depends on its engineering using the filters suggested in this invention. Moreover, the existing devices are costly. Our devices will be very beneficial in rural areas, where poor people still drink surface water being unable to arrange such costly devices. The life of the filters involved in our device is almost one year, and the total estimated cost is almost 5 USD (bucket+three filters).

Artificial hard water (refer Table 1 for the composition) and surface water (the composition is provided in Table 1) was used to perform the experiments. The hardness removal efficiency of the second composite filter, using artificial hard water, and surface water, is shown in FIG. 3, indicating the significant efficacy of purification by our designed filters. Table 2 shows the hardness data after filtration.

Moreover, our designed device works principally on the gravitational concept. More the height of surface water in the filtration chamber (104), the more will be the filtration and the rate of filtration will be reduced with the decreasing height of available surface water being purified. In that context, it may be concluded that wastage in our device would be negligible compared to all available technology with an obvious fall in the rate of purification with a reduced height of available surface water in the filtration chamber (104). Therefore, to maintain the filtration rate, maintaining surface water height in the chamber is advisable.

To check the antibacterial results, artificial hard water and surface water was used. Estimation of pathogens is made before and after filtration in 3^{rd} step, no pathogen is traced after filtration. In addition, the antimicrobial activity of the composite filters 2 and 3 was checked, and the results are illustrated in Table 3. The results confirm that the invented device succeeded in removing the pathogenic contamination from the surface water, providing potable water (FIG. 6).

Usually, the existing water purifier devices showed the 95-99.9% removal of hardness of water and pathogens. However, with our device, the removal of the hardness of water and pathogens can be achieved approximately. 85-90%.

FIG. 7 illustrates the antimicrobial Activity of Composite Filter 3 at 100 mg/ml concentration, in accordance with an embodiment of the present disclosure.

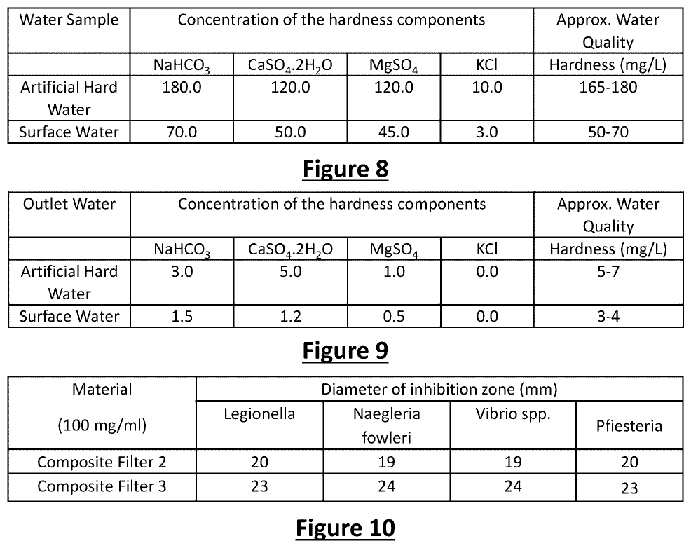

FIG. 8 illustrates Table 1 depicts the chemical composition of artificial water and surface water, in accordance with an embodiment of the present disclosure. The antibacterial activity of the material of filter third is tested against Legionella, Naegleria fowleri, Vibrio spp., and Pfiesteria, and the results (zone of inhibition in mm) are presented in Table 1.

FIG. 9 illustrates Table 2 depicts the chemical composition of outlet (106) water after filtration, in accordance with an embodiment of the present disclosure.

FIG. 10 illustrates Table 3 depicts the antimicrobial activity of Filter 2 and 3, in accordance with an embodiment of the present disclosure.

The designed device works principally on the gravitational concept. More the height of surface water in the filtration chamber (104), the more will be the filtration and the rate of filtration will definitely be reduced with the decreasing height of available surface water being purified. In that context, it may be concluded that wastage in our device would be negligible compared to all available technology with an obvious fall in the rate of purification with reduced height of available surface water in the filtration chamber (104). Therefore, to maintain the filtration rate, maintaining surface water height in the chamber is advisable.

The implementation of designed filters in the bucket can be adjusted as below;

Inlet Chamber (102): The of this chamber can be adjusted according to volumetric capacity to store surface water.

Filtration Chamber (104): This chamber contains three composite filters, namely filter 1, filter 2, and filter 3. The surface water from the top goes through the filters with the gravitational speed towards the bottom of the bucket, where, the outlet (106) is adjusted.

Purification Mechanism: The mechanism involved in the removal of water hardness, carcinogenic metals, and pathogens during filtration is illustrated below.

These filters can be adjusted in a water bucket, arranging in 3-4 columns (depending on requirements) systematically, the first filter (104A) at the top of the column, the second filter (104B) at the middle of the column, and the third filter (104C) at the bottom of the column as shown in FIG. 6.

After passing surface water through these filters, nearly 100% of the hardness and carcinogenic metals can be filtered out, and the pathogenic organisms are reduced by nearly 70%. However, after passing through the third bed, the remaining pathogens are eliminated.

The working process of the invented devices is as below.

### Process of Filter 1

This filter effectively eliminates particulate matter such as dust clouds and muddy particles.

### Process of Filter 2

Usually, zeolites can be used as cation exchangers and molecular sieves. In this filter, the Ca²⁺ and Mg²⁺ ions of hard water get trapped in zeolites pores, and exchanged with Na⁺ ions, and released Na⁺ gets trapped on the Fe₃O₄ nanoparticles, removing the hardness of the water. Table 1 and Table 2 showed the hardness data before the filtration and after filtration, respectively. FIG. 5 shows a simple comparison of the removal of hardness of water from artificial hard water, drinking water, and surface water using filters 2 and 3.

In addition, the carcinogenic metals, Arsenic, cadmium, and chromium, in particular, possess high affinity towards O-atoms and get adsorbed on Fe₃O₄ nanoparticles via O-functionalities. To evaluate the feasibility of composite filter 2 (eggshell powder+zeolites+Fe₃O₄ nanoparticles) and composite filter 3 (eggshell powder+zeolites+Fe₃O₄ nanoparticles+AgNO₃ nanoparticles) as an adsorbent for As(V) removal, the adsorption properties of both the composite filters are systematically explored by studying adsorption isotherm, and kinetics. The results showed that the composite filter 2 and 3 has a specific surface area of 320, and 325 m²/g and has excellent adsorption performance, respectively. At 25° C., the initial concentration of As(V) is 31.35 mg/L and 30.43 mg/L for the composite filter 2 and composite filter 3 to adsorb arsenic, respectively. The results indicated the efficiency of removal of As(V) of composite filters 2 and 3 as 98.1% and 91.05% (FIG. 3). The adsorption process of As(V) to these composite filters 2 and 3 could be demonstrated by the Langmuir isotherm second-order kinetic model, demonstrating 98.31, and 62.23 mg/g maximum As adsorption capacity, respectively, which can be attributed to higher O-functionalities distributed over the surface area of these composite filters. Therefore, the water passing from the second filter (104B) will be soft, and free from Arsenic, cadmium, and chromium.

### Process of Filter 3

To check the antibacterial activity of filters 2 and 3, artificial hard water and surface water samples are used. Estimation of pathogens is made before and after filtration in 3^{rd} step, no pathogen is traced after filtration. In addition, the antimicrobial activity of the composite filters 2 and 3 was checked, and the results are illustrated in Table 3. The results confirm that the invented device succeeded in removing the pathogenic contamination from the surface water, providing potable water (FIG. 4).

The centrifugation procedure is conducted under ambient conditions, specifically at a temperature of 25° C. and an absolute pressure close to 1 atm, using a rotational speed of 5000 revolutions per minute for 10 minutes.

This invention develops three filters for water purification. When water passes through the first filter (104A), the resulting water will be free from the conventional hardness of water, after that this water passes through the second filter (104B), where all the heavy metal is removed, and finally, the third filter (104C) is for the removal of pathogens. This process yielded water that is free of hardness-inducing salts, carcinogenic salts, and microorganisms.

Present invention makes use of a device with four columns, each of which contains three filtering beds: the top bed is made of functionalized graphene resting on a cotton bed, the middle bed is made of a cotton-supported bed on which a membrane made of neutral powdered egg shells is distributed in a uniform thickness, and the bottom bed is made of a reduced egg-shell membrane resting on a cotton bed. When a sample of water including hardness, carcinogenic metals, and pathogens is transported from the top of the device down the second bed, over 100% of the hardness and carcinogenic metal are filtered out, and the number of pathogenic organisms is reduced by approximately 30%. However, after the third bed, 100% of the pathogens are either destroyed or screened out. This process yielded water that is free of hardness-inducing salts, carcinogenic salts, and microorganisms.

The disclosed water purification filter system boasts a tubular carbon block, a notable feature of this design, set within a cartridge housing. While the carbon block can be conveniently swapped and discarded, the cartridge housing made of plastic can be reused. The design promotes sustainability, as many commercially available pitchers result in the disposal of the entire cartridge—an approach that isn't environmentally conscious.

This filter system adopts activated carbon powder of a designated mesh size for its operations. Among the various mesh sizes, a particular range is preferred when molding the carbon block. The sources for activated carbon span across bituminous, peat, and wood. Coconut shell-derived activated carbon stands out as the preferred type due to its widespread availability and status as a renewable resource.

During the production of the carbon block, coconut shells undergo charring in an eco-friendly manner, ensuring zero methane emissions. To further refine its efficiency, the block's surface undergoes treatments to amplify its hydrophilicity. The anionic surfactant wetting agents, such as diethylhexyl sodium sulfosuccinate, prove efficient for this task. The carbon block is also engineered to rid water of hazardous metals like lead, cadmium, and mercury. By infusing silver, the block achieves bio-static features, obstructing bacterial growth and subsequent carbon fouling.

Further components of the carbon block include a hydrophilic material and a blend of activated carbon powder and a high molecular weight polymeric binder.

Visually, the purification setup is straightforward. When set within a pitcher or carafe, water intended for filtration is introduced into the topmost chamber. Post-filtration, the purified water gathers in a lower storage compartment. The ingenious cartridge assembly bridges these chambers.

Intricately designed, the cartridge assembly sports both upper and lower sections. The replaceable carbon block filter finds its place within this structure. The upper section incorporates openings that usher water into the cartridge, while the lower section, a sealed entity, features a bottom opening. Remarkably, the carbon block's bottom is sealed off using a biodegradable cap, perfectly aligning with the lower section's opening. This configuration permits communication between the block's interior and the pitcher's bottom storage.

A biodegradable plastic cap graces the carbon block's top end. It secures an air vent tube, pivotal for efficient water flow. The cartridge's lower section gets topped with a plastic cover, ensuring segregation of the water in the pitcher's two chambers.

For filtration, water courses from the block's exterior to its core, purifying it in the process. As water permeates the carbon block, air within is vented out, promoting swift water flow rates. Clean water then accumulates in the pitcher's base.

The advanced water purification device, designed to work principally on the force of gravity, offers a unique filtration mechanism, integrating a conventional filter system with a modern three-tiered filtration chamber. The primary design utilizes a carbon block of tubular design positioned within a cartridge housing, exhibiting the innovative essence of the invention. Notably, this carbon block can be conveniently replaced and discarded, ensuring that only the plastic cartridge housing is reused. This contrasts sharply with many commercially available pitchers, where the complete cartridge, encompassing both the plastic housing and the carbon media, is discarded, representing a departure from eco-friendly designs.

The inlet chamber (102), can be calibrated based on its volumetric capacity and is positioned atop the assembly to house surface water. Positioned strategically below this chamber is the filtration chamber (104). This chamber incorporates:

A first filter (104A) formulated from a specific blend of zeolite and acid-fractionalized activated charcoal, with the latter originating from various sources like bituminous, peat, and wood, with a predilection for coconut shell-based activated carbon due to its sustainable attributes. This filter layer rests on a supportive bed of cotton.

A second filter (104B) is an innovative concoction of powdered eggshell membrane, zeolite, and Fe₃O₄ nanoparticles.

The third filter (104C) is a sophisticated blend of eggshell membrane powder, zeolite, Fe₃O₄, and AgNO₃ nanoparticles, all underpinned on a cotton bed.

A pivotal component of the present filter system is activated carbon powder, which possesses a specific mesh size. Coconut shells, preferred for their sustainability, undergo charring in an environmentally-conscious procedure, releasing no methane. The resulting carbon block undergoes surface modifications, one being the use of an anionic surfactant wetting agent. Additionally, this block is conditioned to enhance its capacity to extract heavy metals, with silver impregnation to arrest bacterial growth. The cartridge assembly, containing this multi-tiered filtration system, governs the water flow between the upper inlet chamber and the lower outlet chamber (106).

Ensuring efficient water filtration, the design prompts the water to transition from the block's exterior to its interior. The water in the inlet chamber, post-filtering, gets directed via an air vent tube mechanism, bolstering flow rates, before making its way to the outlet (106). Once filtration efficiency wanes, the carbon block replacement is straightforward, curtailing waste by only discarding the carbon block.

The holistic design is malleable, adjusting to the water pitcher's architecture or specific flow rate requirements. Its application is not confined to pitchers but extends to any gravitation-driven water purification system. The chamber design within the housing can be redefined based on the impurities in the water to enhance purification.

This water purification apparatus is structured in a bucket-like form, where the filters are systematically columned. It ensures that the first filter (104A) occupies the topmost position, followed by the second filter (104B), and finally, the third filter (104C) rests at the bottom. Upon the passage of surface water through this triad of filters, the device is adept at eliminating nearly 100% of hardness and carcinogenic metals, with pathogenic organisms seeing a 70% reduction. Any residual pathogens encounter their demise post the third filter (104C), underscoring the device's efficacy.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A water purification device, the device comprising:
a) an inlet chamber adjustable based on a volumetric capacity mounted on a top section for storing surface water;
b) a filtration chamber placed beneath the inlet chamber housing:
a first filter made up of a 1:3 mixture of zeolite and acid-fractionalized activated charcoal, supported on a cotton bed;
a second filter consisting of powdered eggshell membrane mixed with zeolite and Fe₃O₄ nanoparticles in a 5:3:1 ratio;
a third filter composed of a mixture of eggshell membrane powder, zeolite, Fe₃O₄, and AgNO₃ nanoparticles, all supported on a cotton bed in a 5:3:1:1 ratio;
c) an outlet adjusted at a bottom section for collecting purified water; and
wherein the surface water enters from a top of the filtration chamber and is subjected to gravitational force, leading it through the series of filters towards the outlet , and wherein the first, second, and third filters are adjusted in a bucket-like container, systematically arranged in columns, wherein the first, second, and third filters are positioned in such a way that the first filter is at the top, the second filter is in the middle, and the third filter is at the bottom, wherein after the surface water passes through the series of filters, nearly 100% of hardness and carcinogenic metals are filtered out, and the pathogenic organisms are reduced by nearly 70%, wherein any remaining pathogenic organisms are substantially eliminated after passing through the third filter.

2. The water purification device of claim 1, wherein the first filter comprises a perforated support structure integrated within a filter medium to promote uniform flow distribution and maximize contact between untreated water and the filtration media, wherein the second filter further including a magnetic separation feature using Fe₃O₄ nanoparticles for capturing iron particles, wherein the third filter incorporating an antibacterial mechanism with AgNO₃ nanoparticles, along with a quick-detach mechanism for easy replacement and periodic maintenance, wherein a flow control and monitoring system with sensors within the filtration chamber to monitor filter saturation levels and a variable flow control mechanism adjusting flow rate based on contamination levels.

3. The water purification device of claim 1, wherein the first filter further comprises an activated carbon to enhance the removal of organic contaminants from the surface water, wherein the second filter includes a self-cleaning mechanism using ultrasonic vibrations to dislodge and remove accumulated contaminants, thereby extending the lifespan of the second filter, wherein the third filter incorporates a photocatalytic material in conjunction with AgNO₃ nanoparticles, facilitating the degradation of organic pollutants and enhancing the antibacterial properties of the filtration process.

4. A method of preparing the water purification device of claim 1, the method comprising:
a) mounting an inlet chamber at a top of a bucket;
b) designing a filtration chamber by:
preparing and arranging a first filter positioned at a top of a column;
preparing and arranging a second filter positioned in a middle of the column;
preparing and arranging a third filter positioned at a bottom of the column;
b) arranging one or more filtration chambers inside the bucket parallelly and maintaining a surface water height from the filtration chambers to sustain a user-defined filtration rate; and
c) adjusting an outlet at a bottom of the bucket for collecting purified water from the bucket.

5. The method of claim 4, wherein preparing the first filter comprising:
performing charcoal acid treatment by placing 1 g of activated charcoal into a 500 mL flask and adding 10 mL of concentrated HNO₃ to the flask followed by adding 30 mL of concentrated H₂SO₄ to prepare a mixture;
swirling the mixture gently to evenly distribute the mixture;
heating the flask at 120° C. upon tightly closing the flask to avoid evaporation, wherein a heating mantle or a water bath is employed for controlled heating;
removing the flask from the heat source and allowing it to cool to room temperature thereby transferring a resultant suspension to centrifuge tubes;
centrifuging the suspension to separate the acid-treated charcoal from the liquid;
discarding the supernatant (upper liquid layer) from the centrifuge tubes and add distilled water to the charcoal residue and swirl to wash followed by centrifuging again to separate the water from the charcoal;
repeating the washing process several times until the wash water is neutral and spreading the charcoal out on a drying tray or using an oven to dry to obtain a dry black powder;
preparing filter bed by:
mixing zeolite and dried acid-treated charcoal in a 1:1 ratio using a mortar and
pestle thereby grinding the mixture until a homogenous paste is formed; and
applying the charcoal-zeolite paste onto a cotton bed uniformly and allowing the filter to dry.

6. The method of claim 4, wherein preparing the second filter comprising:
extracting egg shell by drilling a small hole in the egg and removing egg white or yolk thereby rinsing an interior of the egg shell with water to remove any residual egg white or yolk;
submerging the eggshell in a solution of 0.1 M acetic acid and soaking the eggshell for 6 hours;
separating a membrane from the dissolved CaCO₃ layer of the eggshell post-soak by peeling off the membrane away from the remaining shell fragments;
cleaning the membrane by rinsing the separated membrane with deionized water until neutrality is achieved;
drying the rinsed membrane and pulverizing the membrane into a fine powder using the mortar and pestle;
preparing filter bed by:
combining the powdered eggshell, zeolite, and Fe₃O₄ nanoparticles in a 5:3:1 ratio, respectively, and mixing thoroughly until a homogenous paste is formed; and
applying the homogenous paste onto a cotton bed and drying the filter.

7. The method of claim 4, wherein preparing the third filter comprising:
mixing the powdered eggshell, zeolite, Fe₃O₄, and AgNO₃ nanoparticles in a 5:3:1:1 ratio, respectively;
heating the combined solution to approximately 90° C. Stir the mixture continuously while heating it to 90° C.;
maintaining the solution at 90° C. while continuously stirring for about 3 hours;
adding a KOH solution to the heated mixture;
agitating the mixture containing the KOH solution at room temperature for an additional 2 hours until neutralization is achieved;
spreading the resultant uniform paste onto a cotton bed to form the filter; and
allowing the applied paste on the cotton bed to set and dry, thereby yielding a filter ready for use.

8. The method of claim 4, further comprising filtering surface water using the water purification device, said filtering surface water comprising:
receiving and storing surface water inside the inlet chamber;
passing the surface water through the filtration chamber to filter impurities from the surface water, wherein water passes sequentially through the first, second, and third filters, resulting in purified water devoid of particulate matter, significant hardness, carcinogenic metals, and pathogenic organisms;
storing the filtered water in the bucket; and
collecting purified water from the bucket through the outlet.

9. The method of claim 8, wherein the first filter further comprising an activated carbon to enhance the removal of organic contaminants from the surface water, wherein the second filter includes a self-cleaning mechanism using ultrasonic vibrations to dislodge and remove accumulated contaminants, thereby extending the lifespan of the second filter, wherein the third filter incorporates a photocatalytic material in conjunction with AgNO₃ nanoparticles, facilitating the degradation of organic pollutants and enhancing the antibacterial properties of the filtration process.

10. The method of claim 8, further comprising:
pre-treating the surface water with a pre-filtration unit positioned upstream of the filtration chamber (104), the pre-filtration unit configured to remove large debris and coarse particles before the surface water enters the first filter; and
filtering water stored in the bucket by a UV-C irradiation, the UV-C irradiation is configured to deactivate residual pathogenic organisms, ensuring microbial safety of the stored purified water.
